(19) United States
(12) Patent Application Publication
(10) Pub. No.: US 2022/0343429 A1
(43) Pub. Date: Oct. 27, 2022

(54) METHOD AND SYSTEM FOR AUTOMATED EVENT MANAGEMENT

(71) Applicant: JPMorgan Chase Bank, N.A., New York, NY (US)

(72) Inventors: Srinivasa R. YENAMADALA, Glen Mills, PA (US); Inderjit Singh AHLUWALIA, Middlesex (GB); Debraj MAJUMDAR, Metuchen, NJ (US)

(73) Assignee: JPMorgan Chase Bank, N.A., New York, NY (US)

(21) Appl. No.: 17/238,765

(22) Filed: Apr. 23, 2021

(51) Int. Cl. G06Q 40/06

(52) U.S. Cl. CPC G06Q 40/06

(57) ABSTRACT

A method for facilitating automated event management by using captured data is provided. The method includes capturing raw data from a source, the raw data corresponding to an agreement; converting the captured raw data into an event data set, the event data set including information that relates to an occurrence of an event; retrieving a set of rules that corresponds to the agreement; generating a chronological representation of the agreement based on the event data set and the retrieved set of rules; and determining an action based on the event data set, the retrieved set of rules, and the generated chronological representation.

### BACKGROUND

### 1. Field of the Disclosure

This technology generally relates to methods and systems for managing events, and more particularly to methods and systems for facilitating automated event management for complex agreements by using captured event data and a corresponding timeline to determine appropriate actions.

### 2. Background Information

Many business entities provide services to consumers based on complex agreements which define intricate legal relationships. The complex agreements often require the business entities to take specific actions when certain events such as, for example, life events occur for a party to the agreement. Historically, conventional techniques for managing the complex agreements between various parties have resulted in varying degrees of success with respect to utility and efficiency.

One drawback of using conventional techniques to manage the complex agreements is that in many instances, data for each of the events must be manually captured and interpreted. As a result, the processing of the data to identify corresponding actions often increases operational risks associated with the management of the agreements due to an increased error probability. Additionally, the identified actions are frequently difficult to track for auditing purposes due to inherent inconsistencies in the manual identification process across the various events and agreements.

Therefore, there is a need for a platform that automates the management of events by efficiently capturing event data from a plurality of sources to generate corresponding timelines that facilitate consistent action identification and initiation.

### SUMMARY

The present disclosure, through one or more of its various aspects, embodiments, and/or specific features or sub-components, provides, inter alia, various systems, servers, devices, methods, media, programs, and platforms for facilitating automated event management for complex agreements by using captured event data and a corresponding timeline to determine appropriate actions.

According to an aspect of the present disclosure, a method for facilitating automated event management by using captured data is provided. The method is implemented by at least one processor. The method may include capturing raw data from at least one source, the raw data may correspond to at least one agreement; converting the captured raw data into at least one event data set, the at least one event data set may include information that relates to an occurrence of an event; retrieving at least one set of rules that corresponds to the at least one agreement; generating at least one chronological representation of the at least one agreement based on at least one from among the at least one event data set and the retrieved at least one set of rules; and determining at least one action based on at least one from among the at least one event data set, the retrieved at least one set of rules, and the generated at least one chronological representation.

In accordance with an exemplary embodiment, the at least one agreement may include at least one trust agreement that relates to a fiduciary relationship between a plurality of parties for the management of an asset.

In accordance with an exemplary embodiment, the at least one chronological representation may include at least one from among an event diary and an event timeline that corresponds to the at least one agreement.

In accordance with an exemplary embodiment, the determined at least one action may include a workflow action that relates to an orchestrated sequence of activities that is initiated by a corresponding downstream processing platform.

In accordance with an exemplary embodiment, the method may further include receiving, via a graphical user interface, at least one request for information that relates to the at least one agreement, the at least one request may include an identifier that corresponds to the at least one agreement; and displaying, via the graphical user interface, the at least one chronological representation in a dashboard in response to the at least one request.

In accordance with an exemplary embodiment, the method may further include automatically initiating the determined at least one action based on at least one predetermined criterion, the at least one predetermined criterion may include the occurrence of the event; and updating the generated at least one chronological representation for the at least one agreement with information that relates to the initiated at least one action.

In accordance with an exemplary embodiment, the method may further include determining, by using at least one model, at least one suggested action based on at least one from among the at least one event data set, the retrieved at least one set of rules, and the generated at least one chronological representation; displaying, via a graphical user interface, the at least one suggested action; receiving, via the graphical user interface, a selection of the at least one suggested action from a user; and automatically initiating the selected at least one suggested action.

In accordance with an exemplary embodiment, the at least one model may include at least one from among a machine learning model, a statistical model, a mathematical model, a process model, and a data model.

In accordance with an exemplary embodiment, the method may further include determining, by using the at least one model, at least one parameter that corresponds to each of the at least one suggested action, the at least one parameter may include a time when the corresponding at least one suggested action must take effect; and automatically initiating the selected at least one suggested action based on the corresponding at least one parameter.

In accordance with an exemplary embodiment, the method may further include displaying, via the graphical user interface, an alert based on the determined at least one parameter, the alert may include information that relates to the automatic initiation of the selected at least one suggested action; receiving, via the graphical user interface, an approval indication from the user; and automatically initiating the selected at least one suggested action when the corresponding at least one parameter is satisfied.

According to an aspect of the present disclosure, a computing device configured to implement an execution of a method for facilitating automated event management by using captured data is disclosed. The computing device comprising a processor; a memory; and a communication interface coupled to each of the processor and the memory, wherein the processor may be configured to capture raw data from at least one source, the raw data may correspond to at least one agreement; convert the captured raw data into at least one event data set, the at least one event data set may include information that relates to an occurrence of an event; retrieve at least one set of rules that corresponds to the at least one agreement; generate at least one chronological representation of the at least one agreement based on at least one from among the at least one event data set and the retrieved at least one set of rules; and determine at least one action based on at least one from among the at least one event data set, the retrieved at least one set of rules, and the generated at least one chronological representation.

In accordance with an exemplary embodiment, the at least one agreement may include at least one trust agreement that relates to a fiduciary relationship between a plurality of parties for the management of an asset.

In accordance with an exemplary embodiment, the at least one chronological representation may include at least one from among an event diary and an event timeline that corresponds to the at least one agreement.

In accordance with an exemplary embodiment, the determined at least one action may include a workflow action that relates to an orchestrated sequence of activities that is initiated by a corresponding downstream processing platform.

In accordance with an exemplary embodiment, the processor may be further configured to receive, via a graphical user interface, at least one request for information that relates to the at least one agreement, the at least one request may include an identifier that corresponds to the at least one agreement; and display, via the graphical user interface, the at least one chronological representation in a dashboard in response to the at least one request.

In accordance with an exemplary embodiment, the processor may be further configured to automatically initiate the determined at least one action based on at least one predetermined criterion, the at least one predetermined criterion may include the occurrence of the event; and update the generated at least one chronological representation for the at least one agreement with information that relates to the initiated at least one action.

In accordance with an exemplary embodiment, the processor may be further configured to determine, by using at least one model, at least one suggested action based on at least one from among the at least one event data set, the retrieved at least one set of rules, and the generated at least one chronological representation; display, via a graphical user interface, the at least one suggested action; receive, via the graphical user interface, a selection of the at least one suggested action from a user; and automatically initiate the selected at least one suggested action.

In accordance with an exemplary embodiment, the at least one model may include at least one from among a machine learning model, a statistical model, a mathematical model, a process model, and a data model.

In accordance with an exemplary embodiment, the processor may be further configured to determine, by using the at least one model, at least one parameter that corresponds to each of the at least one suggested action, the at least one parameter may include a time when the corresponding at least one suggested action must take effect; and automatically initiate the selected at least one suggested action based on the corresponding at least one parameter.

In accordance with an exemplary embodiment, the processor may be further configured to display, via the graphical user interface, an alert based on the determined at least one parameter, the alert may include information that relates to the automatic initiation of the selected at least one suggested action; receive, via the graphical user interface, an approval indication from the user; and automatically initiate the selected at least one suggested action when the corresponding at least one parameter is satisfied.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated event management for complex agreements by using captured event data and a corresponding timeline to determine appropriate actions.

FIG. 4 is a flowchart of an exemplary process for implementing a method for facilitating automated event management for complex agreements by using captured event data and a corresponding timeline to determine appropriate actions.

FIG. 5 is a diagram of an exemplary computing architecture for implementing a method for facilitating automated event management for complex agreements by using captured event data and a corresponding timeline to determine appropriate actions.

FIG. 6 is a screen shot that illustrates a graphical user interface of a trust profile that is usable for implementing a method for facilitating automated event management for complex agreements by using captured event data and a corresponding timeline to determine appropriate actions, according to an exemplary embodiment.

FIG. 7 is a screen shot that illustrates a graphical user interface of a processing review screen that is usable for implementing a method for facilitating automated event management for complex agreements by using captured event data and a corresponding timeline to determine appropriate actions, according to an exemplary embodiment.

FIG. 8 is a screen shot that illustrates a graphical user interface of a timeline that is usable for implementing a method for facilitating automated event management for complex agreements by using captured event data and a corresponding timeline to determine appropriate actions, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

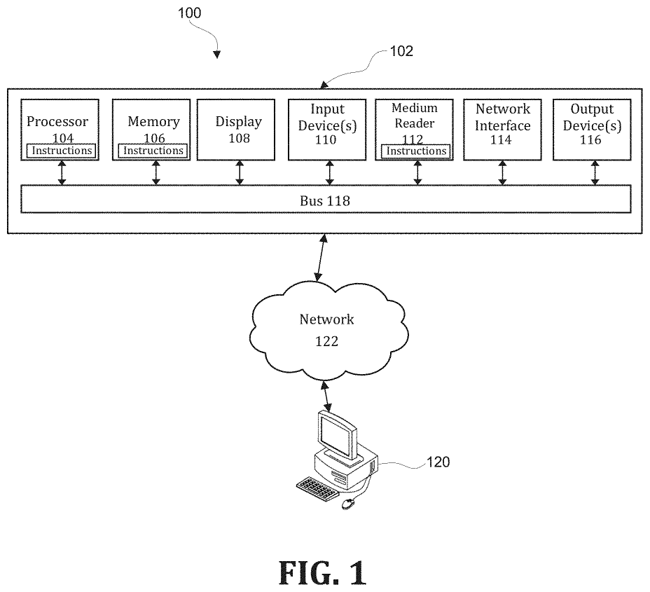

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated event management for complex agreements by using captured event data and a corresponding timeline to determine appropriate actions.

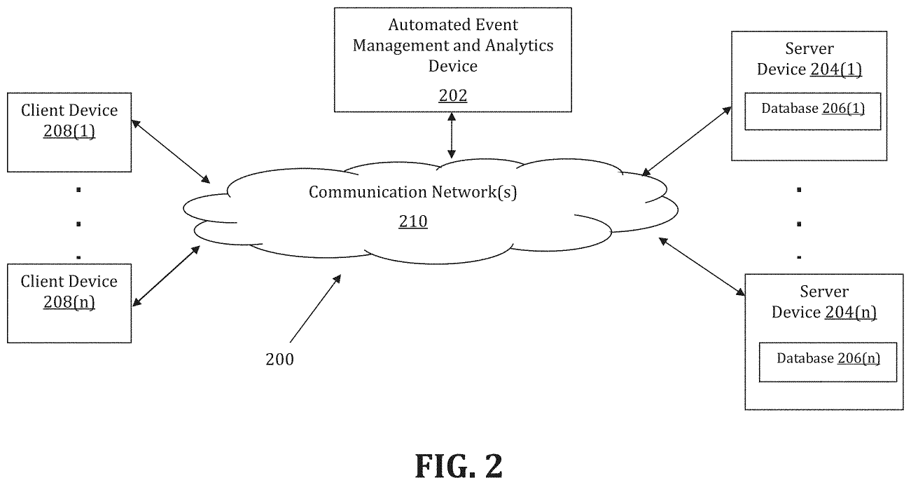

Referring to FIG. 2, a schematic of an exemplary network environment 200 for implementing a method for facilitating automated event management for complex agreements by using captured event data and a corresponding timeline to determine appropriate actions is illustrated. In an exemplary embodiment, the method is executable on any networked computer platform, such as, for example, a personal computer (PC).

The method for facilitating automated event management for complex agreements by using captured event data and a corresponding timeline to determine appropriate actions may be implemented by an Automated Event Management and Analytics (AEMA) device 202. The AEMA device 202 may be the same or similar to the computer system 102 as described with respect to FIG. 1. The AEMA device 202 may store one or more applications that can include executable instructions that, when executed by the AEMA device 202, cause the AEMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AEMA device 202 itself, may be located in virtual server(s) running in a cloud-based computing environment rather than being tied to one or more specific physical network computing devices. Also, the application(s) may be running in one or more virtual machines (VMs) executing on the AEMA device 202. Additionally, in one or more embodiments of this technology, virtual machine(s) running on the AEMA device 202 may be managed or supervised by a hypervisor.

In the network environment 200 of FIG. 2, the AEMA device 202 is coupled to a plurality of server devices 204(1)-204(n) that hosts a plurality of databases 206(1)-206(n), and also to a plurality of client devices 208(1)-208(n) via communication network(s) 210. A communication interface of the AEMA device 202, such as the network interface 114 of the computer system 102 of FIG. 1, operatively couples and communicates between the AEMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AEMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AEMA devices that efficiently implement a method for facilitating automated event management for complex agreements by using captured event data and a corresponding timeline to determine appropriate actions.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AEMA device 202 may be a standalone device or integrated with one or more other devices or apparatuses, such as one or more of the server devices 204(1)-204(n), for example. In one particular example, the AEMA device 202 may include or be hosted by one of the server devices 204(1)-204(n), and other arrangements are also possible. Moreover, one or more of the devices of the AEMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AEMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw data, agreement data, event data sets, rules data, chronological representation data, timeline data, diary data, action data, and model data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AEMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AEMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AEMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AEMA device 202, the server devices 204(1)-204(n), or the client devices 208(1)-208(n), for example, may be configured to operate as virtual instances on the same physical machine. In other words, one or more of the AEMA device 202, the server devices 204(1)-204(n), or the client devices 208(1)-208(n) may operate on the same physical device rather than as separate devices communicating through communication network(s) 210. Additionally, there may be more or fewer AEMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

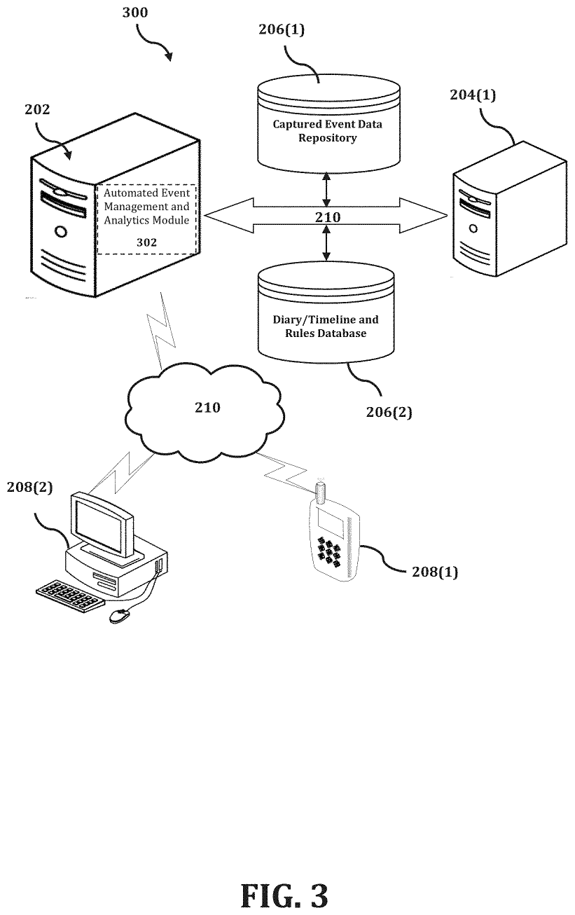

The AEMA device 202 is described and shown in FIG. 3 as including an automated event management and analytics module 302, although it may include other rules, policies, modules, databases, or applications, for example. As will be described below, the automated event management and analytics module 302 is configured to implement a method for facilitating automated event management for complex agreements by using captured event data and a corresponding timeline to determine appropriate actions.

An exemplary process 300 for implementing a mechanism for facilitating automated event management for complex agreements by using captured event data and a corresponding timeline to determine appropriate actions by utilizing the network environment of FIG. 2 is shown as being executed in FIG. 3. Specifically, a first client device 208(1) and a second client device 208(2) are illustrated as being in communication with AEMA device 202. In this regard, the first client device 208(1) and the second client device 208(2) may be “clients” of the AEMA device 202 and are described herein as such. Nevertheless, it is to be known and understood that the first client device 208(1) and/or the second client device 208(2) need not necessarily be “clients” of the AEMA device 202, or any entity described in association therewith herein. Any additional or alternative relationship may exist between either or both of the first client device 208(1) and the second client device 208(2) and the AEMA device 202, or no relationship may exist.

Further, AEMA device 202 is illustrated as being able to access a captured event data repository 206(1) and a diary/timeline and rules database 206(2). The automated event management and analytics module 302 may be configured to access these databases for implementing a method for facilitating automated event management for complex agreements by using captured event data and a corresponding timeline to determine appropriate actions.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AEMA device 202 via broadband or cellular communication. Of course, these embodiments are merely exemplary and are not limiting or exhaustive.

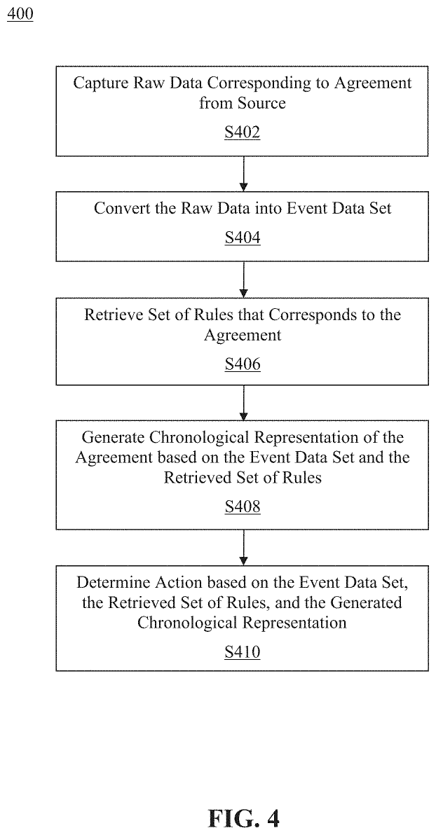

Upon being started, the automated event management and analytics module 302 executes a process for facilitating automated event management for complex agreements by using captured event data and a corresponding timeline to determine appropriate actions. An exemplary process for facilitating automated event management for complex agreements by using captured event data and a corresponding timeline to determine appropriate actions is generally indicated at flowchart 400 in FIG. 4.

In the process 400 of FIG. 4, at step S402, raw data may be captured from a plurality of sources. The raw data may correspond to an agreement. In an exemplary embodiment, the agreement may include a trust agreement that relates to a fiduciary relationship between a plurality of parties for the management of an asset. For example, the trust agreement may establish a legal relationship in which legal title to property is entrusted to a legal entity with a fiduciary duty to hold and use the property for benefit of another. In another exemplary embodiment, the agreement may include a contractual agreement between a plurality of parties that requires the triggering of specific actions based on the occurrence of an event. As will be appreciated by a person of ordinary skill in the art, the agreement may include any relationship between a plurality of parties such as, for example, a vendor and client relationship as well as an employee and employer relationship that requires the triggering of actions based on specified events.

In another exemplary embodiment, the raw data may be captured from a plurality of sources via an application programming interface (API). The API may include an interface that defined interactions between software intermediaries. The API may define the kinds of calls that can be made, how to make the calls, the data formats that should be used, and the conventions to follow. In another exemplary embodiment, the plurality of sources may include first-party sources such as, for example, internal governing document management systems as well as third-party sources such as, for example, external birth record management systems. The plurality of sources may be connected via a private computer network such as, for example, an enterprise network and a public computer network such as, for example, a global system of interconnected computer networks that uses the internet protocol suite to communicate between networks and devices.

At step S404, the captured raw data may be converted into an event data set. In an exemplary embodiment, the event data set may include information that relates to an occurrence of an event such as, for example, a death of a beneficiary. The event data set may correspond to event data that have been extracted from the captured raw data. In another exemplary embodiment, the raw data captured from the plurality of sources may include event data in a variety of formats. For example, the raw data may include event data in a word processing document format, a tabular format, and a portable document format. In another exemplary embodiment, software components such as, for example, optical character recognition (OCR) software components may be utilized to capture event information from the raw data. The OCR process may relate to the electronic conversion of images of typed, handwritten, and/or printed test into machine-encoded text. As will be appreciated by a person of ordinary skill in the art, any electronic text conversion process may be utilized to convert the image data into machine-encoded text.

At step S406, a set of rules that corresponds to the agreement may be retrieved. The set of rules may be retrieved from a networked repository that persists predetermined rules for a variety of agreements. In an exemplary embodiment, the set of rules may relate to predetermined business guidelines for the processing of specific events. For example, the set of business rules for the processing of an event such as the death of a beneficiary may include disabling access to account information for credentials associated with the deceased beneficiary. In another exemplary embodiment, the set of rules may relate to predetermined regulatory guidelines for the processing of specific events. For example, the set of regulatory rules for the processing of an event such as reaching an age of attainment by a beneficiary may include forwarding disbursement information to a tax agency on behalf of the beneficiary. In another exemplary embodiment, the set of rules may relate to predetermined terms within the agreement for the processing of specific events. For example, the set of rules according to the agreement for the processing of an event such as reaching an age of attainment by a beneficiary may include the disbursement of funds to a specified account.

At step S408, a chronological representation of the agreement may be generated based on the event data set and the retrieved set of rules. The chronological representation may include at least one from among an event diary and an event timeline that corresponds to the agreement. In an exemplary embodiment, the timeline may include a display of a list of the events in chronological order. The timeline may relate to a graphical design that shows a long bar labelled with dates and contemporaneous events.

In another exemplary embodiment, the timeline may include a graphical representation of predetermined events required by the agreement. For example, the timeline for the agreement may include important predetermined events that require action by the party with fiduciary responsibility. In another exemplary embodiment, the timeline may include a graphical representation of past events that have already occurred together with information relating to corresponding actions taken for the past events. For example, the timeline for the agreement may include past fund distribution events and information relating to each of the fund distribution events. As will be appreciated by a person of ordinary skill in the art, the timeline may include a graphical representation of both predetermined events as well as past events.

At step S410, an action may be determined based on the event data set, the retrieved set of rules, and the generated chronological representation. In an exemplary embodiment, the action may correspond to the event in the event data set. For example, the action may include the disbursement of funds to a beneficiary in response to the occurrence of an event such as the satisfaction of an age of attainment requirement. In another exemplary embodiment, the determined action may include a workflow action that relates to an orchestrated sequence of activities that is initiated by a corresponding downstream processing platform. For example, the workflow actions may require further processing by downstream platforms such as a tax platform, a trading platform, and an authority platform.

In another exemplary embodiment, the action may include a required action based on the agreement as well as an optional action based on business needs. The required action may relate to actions that are stipulated in the agreement and must be initiated for a corresponding event. For example, the required action may include a required disbursement of funds to a beneficiary upon satisfaction of the age of attainment requirement. The optional action may relate to actions that are not required by the agreement but may be necessary based on business guidelines. For example, the optional action may include the disabling of system access for credentials associated with a deceased beneficiary.

In another exemplary embodiment, a request for information that relates to the agreement may be received via a graphical user interface. The request may include an identifier that corresponds to the agreement. Then, the chronological representation that corresponds to the agreement may be displayed via the graphical user interface in response to the request. In another exemplary embodiment, the chronological representation may be displayed as a graphical element that includes graphical components that are configured to receive input from a user. For example, the graphical component may include a text box that provides corresponding information for an event of the agreement when a cursor is hovered over the text box as well as when the text box is selected.

In another exemplary embodiment, the determined action may be automatically initiated based on a predetermined criterion. The predetermined criterion may include the occurrence of the event. For example, the predetermined criterion associated with the agreement may require an automatic initiation of the determined action for recurring events such as periodic disbursement of funds to a beneficiary on a certain date. Then, the generated chronological representation for the agreement may be updated with information that relates to the automatically initiated action. In another exemplary embodiment, the determined action may include associated information relating to a predetermined quality of the determined action. The predetermined quality of the determined action may relate to a qualifier such as, for example, whether human approval is required before the determined action may be initiated. In another exemplary embodiment, the determined action may be automatically initiated based on both the predetermined criterion and the predetermined quality associated with the determined action.

In another exemplary embodiment, a suggested action may be determined by using a model based on the event data set, the retrieved set of rules, and the generated chronological representation. The suggested action may be displayed for a user via a graphical user interface. The suggested action may be displayed in a list that is sorted based on a predetermined preference of the user. Then, a selection of the suggested action may be received from the user via the graphical user interface and automatically initiated consistent with disclosures in the present application. As will be appreciated by a person of ordinary skill in the art, the automatic suggesting of appropriate actions may enable the dynamic processing of future events.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that the training model's least squares error rate, true positive rate, true negative rate, false positive rate, and false negative rates are within predetermined ranges. In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, a parameter that corresponds to each of the suggested actions may be determined by using the model. The parameter may include a time when the corresponding suggested action must take effect. Then, the selected suggested action may be automatically initiated based on the corresponding parameter. For example, when each of the suggested actions include a time when the suggested action must take effect, the user may simply select one of the suggested actions to indicate approval of the suggested action and the disclosed system will automatically initiate the selected suggested action at the appropriate time consistent with disclosures in the present application.

In another exemplary embodiment, an alert may be displayed via the graphical user interface based on the determined parameter. The alert may include information that relates to the automatic initiation of the selected suggested action. An approval indication may be received from the user via the graphical user interface in response to the alert. Then, the selected suggested action may be automatically initiated when the corresponding parameter is satisfied. For example, after the user has selected one of the suggested actions, the user may receive an alert when the corresponding parameter is satisfied. The user may then indicate an approval in response to the alert to initiate the selected suggested action consistent with disclosures in the present application.

In another exemplary embodiment, information relating to the event data and the initiated action may be persisted in a networked repository. The networked repository may include a connected data storage component such as, for example, an on-premises data storage component as well as a cloud-based data storage component. In another exemplary embodiment, the persisted information may be maintained by a documentation component and retrieved in response to an audit request.

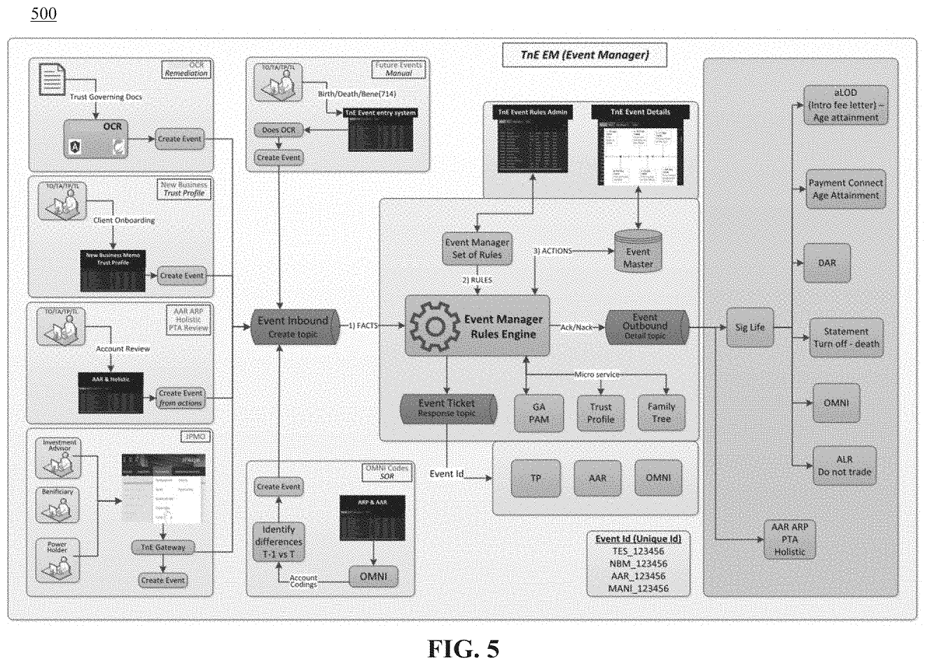

FIG. 5 is a diagram 500 of an exemplary computing architecture for implementing a method for facilitating automated event management for complex agreements by using captured event data and a corresponding timeline to determine appropriate actions. In FIG. 5, the event manager component may process event data, take actions based on processing output of the event data, notify downstream clients and subscribed clients, as well as facilitate the subscribing and unsubscribing of clients to particular event types.

As illustrated in FIG. 5, raw data may be gathered from a plurality of sources. The raw data may include manually entered event data, trust governing documents, client onboarding data, account review data, and account coding data. Event data may be generated from the gathered raw data. Then, at step 1, the generated event data may be ingested by the event manager component. At step 2, a rules component may identify and retrieve corresponding rules. Based on the ingested event data and the retrieve corresponding rules, the event manager component may determine appropriate actions for events at step 3. The event manager component may utilize an event master component that manages a chronological representation for a plurality of agreements.

In another exemplary embodiment, the event manager component may initiate the appropriate actions based on at least one from among an approval from a user and a business guideline. The event manager component may utilize an event outbound component to generate detailed topics for a variety of downstream platforms. For example, the downstream platforms may send an introductory fee letter, initiate a payment connect, and turn off statement delivery. The event manager component may connect directly with the variety of downstream platforms to push initiated workflows corresponding to the appropriate actions. In another exemplary embodiment, the event manager component may persist information that relates to the event data and the determined appropriate response for documentation and auditing purposes.

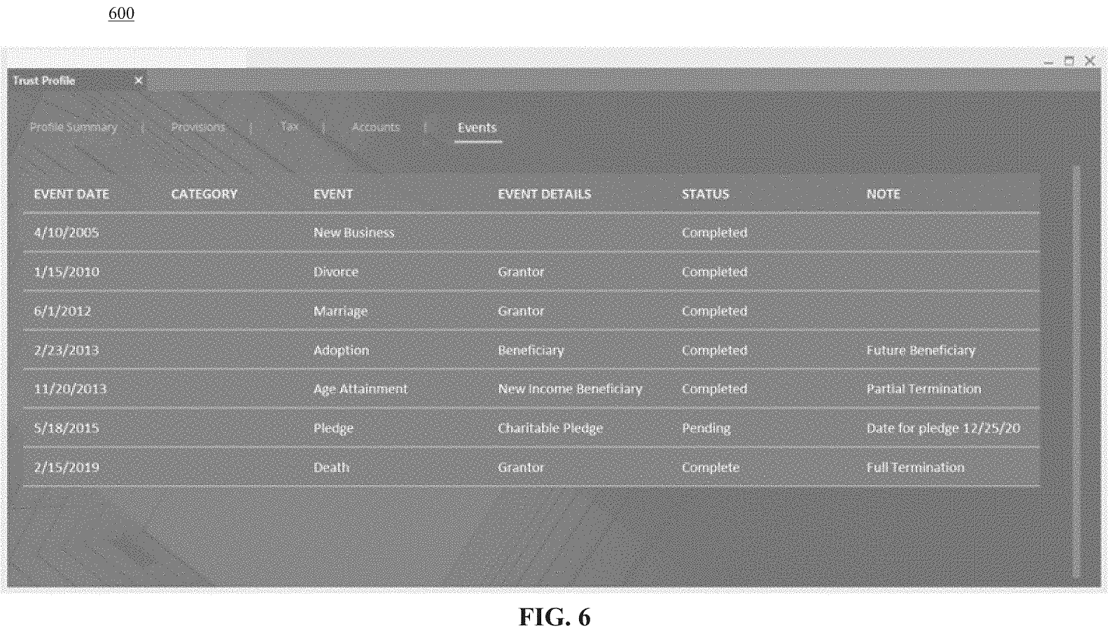

FIG. 6 is a screen shot 600 that illustrates a graphical user interface of a trust profile that is usable for implementing a method for facilitating automated event management for complex agreements by using captured event data and a corresponding timeline to determine appropriate actions, according to an exemplary embodiment. As illustrated in FIG. 6, the trust profile may include a summary of events and corresponding information. For example, on Jan. 15, 2010, a divorce event which affected the grantor was identified. Based on the divorce event, corresponding actions were taken, and a completed status is displayed on the trust profile.

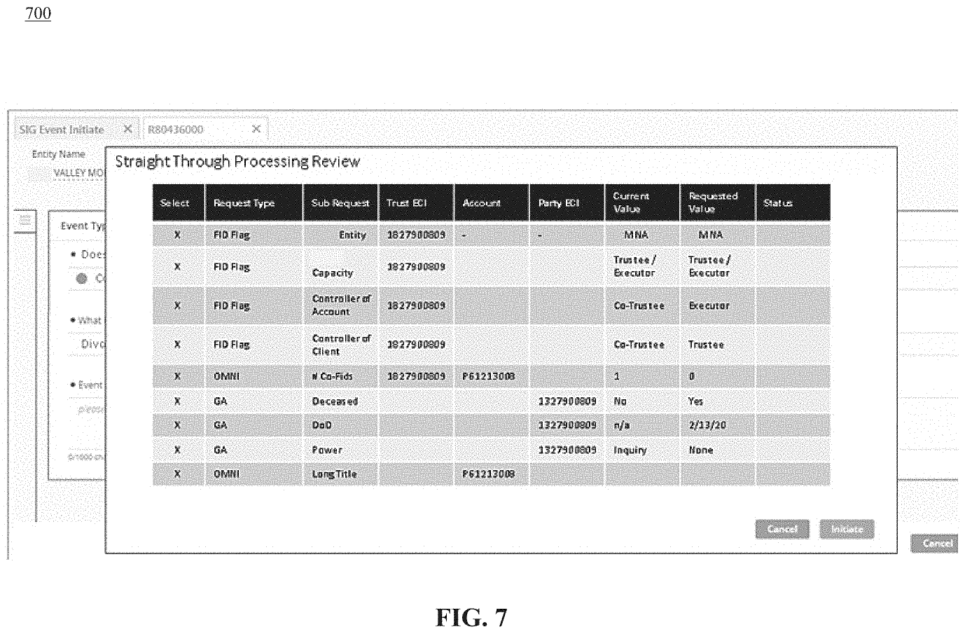

FIG. 7 is a screen shot 700 that illustrates a graphical user interface of a processing review screen that is usable for implementing a method for facilitating automated event management for complex agreements by using captured event data and a corresponding timeline to determine appropriate actions, according to an exemplary embodiment. As illustrated in FIG. 7, the processing review screen may include a listing of suggested actions based on event data. A user may choose any combination of suggested actions such as, for example, a single action as well as several actions by selecting corresponding graphical buttons that are associated with the suggested actions on the processing review screen. The processing review screen may also include graphical elements titled “Initiate” and Cancel.” Selecting the graphical element titled “Initiate” may cause initiation of the chosen actions. Selecting the graphical element titled “Cancel” may close the processing review screen.

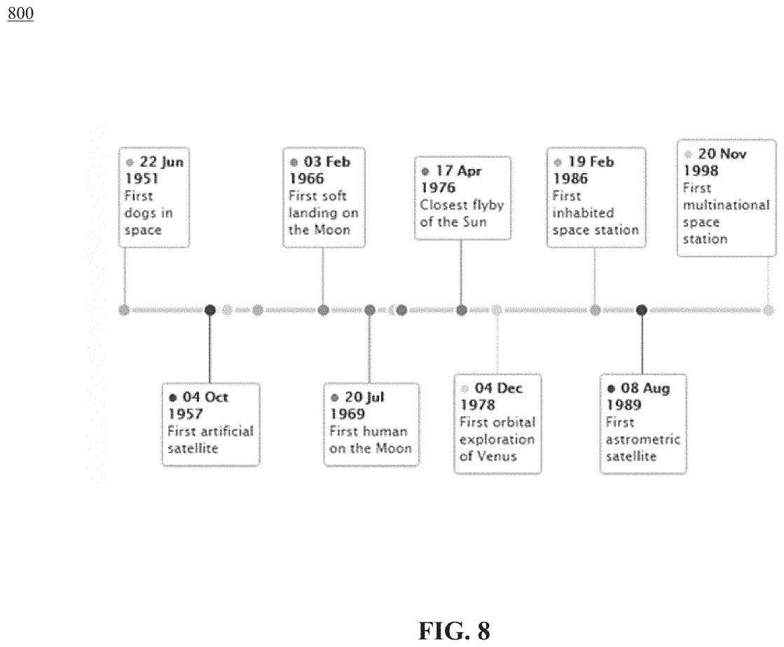

FIG. 8 is a screen shot 800 that illustrates a graphical user interface of a timeline that is usable for implementing a method for facilitating automated event management for complex agreements by using captured event data and a corresponding timeline to determine appropriate actions, according to an exemplary embodiment. As illustrated in FIG. 8, a timeline is used as a chronological representation of an agreement. The timeline may correspond to a display of a list of events in chronological order by showing a long bar labeled with dates and contemporaneous events. Information corresponding to the contemporaneous events may be displayed in a text box. The text box may be configured to receive input from a user and, in response to the input, display additional details relating to the event.

Accordingly, with this technology, an optimized process for facilitating automated event management for complex agreements by using captured event data and a corresponding timeline to determine appropriate actions is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated event management by using captured data, the method being implemented by at least one processor, the method comprising:
capturing, by the at least one processor, raw data from at least one source, the raw data corresponding to at least one agreement;
converting, by the at least one processor, the captured raw data into at least one event data set, the at least one event data set including information that relates to an occurrence of an event;
retrieving, by the at least one processor, at least one set of rules that corresponds to the at least one agreement;
generating, by the at least one processor, at least one chronological representation of the at least one agreement based on at least one from among the at least one event data set and the retrieved at least one set of rules; and
determining, by the at least one processor, at least one action based on at least one from among the at least one event data set, the retrieved at least one set of rules, and the generated at least one chronological representation.

2. The method of claim 1, wherein the at least one agreement includes at least one trust agreement that relates to a fiduciary relationship between a plurality of parties for the management of an asset.

3. The method of claim 1, wherein the at least one chronological representation includes at least one from among an event diary and an event timeline that corresponds to the at least one agreement.

4. The method of claim 1, wherein the determined at least one action includes a workflow action that relates to an orchestrated sequence of activities that is initiated by a corresponding downstream processing platform.

5. The method of claim 1, further comprising:
receiving, by the at least one processor via a graphical user interface, at least one request for information that relates to the at least one agreement, the at least one request including an identifier that corresponds to the at least one agreement; and
displaying, by the at least one processor via the graphical user interface, the at least one chronological representation in a dashboard in response to the at least one request.

6. The method of claim 1, further comprising:
automatically initiating, by the at least one processor, the determined at least one action based on at least one predetermined criterion, the at least one predetermined criterion including the occurrence of the event; and
updating, by the at least one processor, the generated at least one chronological representation for the at least one agreement with information that relates to the initiated at least one action.

7. The method of claim 1, further comprising:
determining, by the at least one processor using at least one model, at least one suggested action based on at least one from among the at least one event data set, the retrieved at least one set of rules, and the generated at least one chronological representation;
displaying, by the at least one processor via a graphical user interface, the at least one suggested action;
receiving, by the at least one processor via the graphical user interface, a selection of the at least one suggested action from a user; and
automatically initiating, by the at least one processor, the selected at least one suggested action.

8. The method of claim 7, wherein the at least one model includes at least one from among a machine learning model, a statistical model, a mathematical model, a process model, and a data model.

9. The method of claim 7, further comprising:
determining, by the at least one processor using the at least one model, at least one parameter that corresponds to each of the at least one suggested action, the at least one parameter including a time when the corresponding at least one suggested action must take effect; and
automatically initiating, by the at least one processor, the selected at least one suggested action based on the corresponding at least one parameter.

10. The method of claim 9, further comprising:
displaying, by the at least one processor via the graphical user interface, an alert based on the determined at least one parameter, the alert including information that relates to the automatic initiation of the selected at least one suggested action;
receiving, by the at least one processor via the graphical user interface, an approval indication from the user; and
automatically initiating, by the at least one processor, the selected at least one suggested action when the corresponding at least one parameter is satisfied.

11. A computing device configured to implement an execution of a method for facilitating automated event management by using captured data, the computing device comprising:
a processor;
a memory; and
a communication interface coupled to each of the processor and the memory,
wherein the processor is configured to:
capture raw data from at least one source, the raw data corresponding to at least one agreement;
convert the captured raw data into at least one event data set, the at least one event data set including information that relates to an occurrence of an event;
retrieve at least one set of rules that corresponds to the at least one agreement;
generate at least one chronological representation of the at least one agreement based on at least one from among the at least one event data set and the retrieved at least one set of rules; and
determine at least one action based on at least one from among the at least one event data set, the retrieved at least one set of rules, and the generated at least one chronological representation.

12. The computing device of claim 11, wherein the at least one agreement includes at least one trust agreement that relates to a fiduciary relationship between a plurality of parties for the management of an asset.

13. The computing device of claim 11, wherein the at least one chronological representation includes at least one from among an event diary and an event timeline that corresponds to the at least one agreement.

14. The computing device of claim 11, wherein the determined at least one action includes a workflow action that relates to an orchestrated sequence of activities that is initiated by a corresponding downstream processing platform.

15. The computing device of claim 11, wherein the processor is further configured to:
receive, via a graphical user interface, at least one request for information that relates to the at least one agreement, the at least one request including an identifier that corresponds to the at least one agreement; and
display, via the graphical user interface, the at least one chronological representation in a dashboard in response to the at least one request.

16. The computing device of claim 11, wherein the processor is further configured to:
automatically initiate the determined at least one action based on at least one predetermined criterion, the at least one predetermined criterion including the occurrence of the event; and
update the generated at least one chronological representation for the at least one agreement with information that relates to the initiated at least one action.

17. The computing device of claim 11, wherein the processor is further configured to:
determine, by using at least one model, at least one suggested action based on at least one from among the at least one event data set, the retrieved at least one set of rules, and the generated at least one chronological representation;
display, via a graphical user interface, the at least one suggested action;
receive, via the graphical user interface, a selection of the at least one suggested action from a user; and
automatically initiate the selected at least one suggested action.

18. The computing device of claim 17, wherein the at least one model includes at least one from among a machine learning model, a statistical model, a mathematical model, a process model, and a data model.

19. The computing device of claim 17, wherein the processor is further configured to:
determine, by using the at least one model, at least one parameter that corresponds to each of the at least one suggested action, the at least one parameter including a time when the corresponding at least one suggested action must take effect; and
automatically initiate the selected at least one suggested action based on the corresponding at least one parameter.

20. The computing device of claim 19, wherein the processor is further configured to:
display, via the graphical user interface, an alert based on the determined at least one parameter, the alert including information that relates to the automatic initiation of the selected at least one suggested action;
receive, via the graphical user interface, an approval indication from the user; and
automatically initiate the selected at least one suggested action when the corresponding at least one parameter is satisfied.
